(19) United States
(12) Patent Application Publication
(10) Pub. No.: US 2017/0072952 A1
(43) Pub. Date: Mar. 16, 2017

(54) DRIVING ASSISTANCE APPARATUS AND DRIVING ASSISTANCE METHOD

(71) Applicant: MANDO CORPORATION, Gyeonggi-do (KR)

(72) Inventor: Sang Kyun SIM, Gyeonggi-do (KR)

(21) Appl. No.: 15/257,907

(22) Filed: Sep. 6, 2016

(30) Foreign Application Priority Data
Sep. 10, 2015 (KR) 10-2015-0128197

(51) Int. Cl. B60W 30/14

(52) U.S. Cl. CPC B60W 30/146; B60W 2550/14; B60W 2420/42; G06K 9/00818

(57) ABSTRACT

Disclosed is a driving assistance apparatus that includes: a sensor configured to sense information received from at least one of a camera configured to speed limit sign information, a navigation system configured to receive GPS information so as to sense road information for a road on which a vehicle is traveling, a vehicle speed sensor configured to sense vehicle speed information, and an input sensor configured to sense whether an input exists or not; a recognizing unit configured to recognize a speed limit based on at least one of the limit speed sign information and the road information; and a control unit configured to control in such a manner that the traveling speed of the vehicle according to the vehicle speed information does not exceed the speed limit. When it is sensed that an input exists, the control is not performed.

### CROSS REFERENCE TO RELATED APPLICATION

This application claims priority from Korean Patent Application No. 10-2015-0128197, filed on Sep. 10, 2015, which is hereby incorporated by reference for all purposes as if fully set forth herein.

### BACKGROUND OF THE INVENTION

1. Field of the Invention

Embodiments relate to a driving assistance technique that controls the traveling speed of a vehicle according to the speed limit of a road where the vehicle travels.

2. Description of the Prior Art

Recently, longitudinal control techniques of a vehicle, which are classified into Adaptive Cruise Control (ACC) and Collision Damage Mitigation (CDM), have been applied to mass production.

The longitudinal control techniques are safety techniques for securing convenience and safety in longitudinal traveling through an acceleration/deceleration control of the vehicle.

The ACC system is to adjust a constant traveling control so as to automatically adjust a kind of cruise control that automatically controls a vehicle speed depending on a traveling situation of the vehicle, in which the vehicle speed may be adjusted so as to maintain a time interval (which is adjustable to several seconds) set between a vehicle equipped with an ACC system and a preceding vehicle by using a throttle control and a restrictive brake while the cruise control unit is being operated.

Thus, the vehicle equipped with the ACC system requires less manual acceleration or deceleration even if a change occurs in traffic flow, and when no preceding vehicle exists during traveling, the vehicle equipped with the ACC system may be restored to the original constant traveling speed, thereby ensuring safety and convenience in traveling.

In addition, the CDM system is a technique that estimates colliding with a forward obstacle, and depending on the collision risk, makes a warning using an electric safety belt, or performs deceleration so as to avoid collision.

However, the longitudinal control techniques for a vehicle, which are classified into ACC and CDM, perform an acceleration/deceleration control of a vehicle based on the distance to objects including vehicles around the vehicle. Thus, a vehicle, which travels on a road where objects including vehicles do not exist around the vehicle, cannot perform such a control, and may operate regardless of the speed limit of the road on which the vehicle travels.

### SUMMARY OF THE INVENTION

In this background, an object of the embodiments is to provide a driving assistance technique that is capable of controlling a traveling speed of a vehicle based on a speed limit of a road on which the vehicle is traveling.

As an aspect, an embodiment provides a driving assistance apparatus that includes: a sensor configured to sense information received from at least one of a camera configured to speed limit sign information, a navigation system configured to receive GPS information so as to sense road information for a road on which a vehicle is traveling, a vehicle speed sensor configured to sense vehicle speed information, and an input sensor configured to sense whether an input exists or not; a recognizing unit configured to recognize a speed limit based a least one of the limit speed sign information and the road information; and a control unit configured to control in such a manner that the traveling speed of the vehicle according to the vehicle speed information does not exceed the speed limit. When it is sensed that an input exists, the control is not performed.

As anther aspect, an embodiment provides a driving assistance method including: a sensing step of sensing at least one of speed limit sign information obtained using a camera, a road information obtained using a navigation system that receives GPS information, vehicle speed information obtained using a vehicle speed sensor, and input information obtained using an input sensor; a recognizing step of recognizing a speed limit based on at least one of the speed limit sign information and the road information; and a control step of controlling the vehicle in such a manner that the traveling speed of the vehicle does not exceed the recognized speed limit. When input information is sensed, the control is not performed.

As described above, according to embodiments, a traveling speed of a vehicle may be controlled according to a speed limit of a road on which the vehicle is traveling, regardless whether objects including vehicles exist around the vehicle.

### BRIEF DESCRIPTION OF THE DRAWINGS

The above and other objects, features, and advantages of the present invention will be more apparent from the following detailed description taken in conjunction with the accompanying drawings, in which:

FIG. 1 is a view illustrating a configuration of a driving assistance apparatus according to one embodiment;

FIG. 2 is a view illustrating an example for describing a driving assistance apparatus according to one embodiment;

FIG. 3 is a view illustrating an example for describing a driving assistance apparatus according to another embodiment;

FIG. 4A is a view illustrating a first example for describing an operation of a driving assistance apparatus according to still another embodiment;

FIG. 4B is a view illustrating a second example for describing an operation of a driving assistance apparatus according to still another embodiment;

FIG. 4C is a view illustrating a third example for describing an operation of a driving assistance apparatus according to still another embodiment; and

FIG. 5 is a view illustrating a flow chart of a driving assistance method according to one embodiment.

### DETAILED DESCRIPTION OF THE EXEMPLARY EMBODIMENT

Hereinafter, some embodiments of the present invention will be described in detail with reference to the accompanying illustrative drawings. In designating elements of the drawings by reference numerals, the same elements will be designated by the same reference numerals although they are shown in different drawings. Further, in the following description of the present invention, a detailed description of known functions and configurations incorporated herein will be omitted when it may make the subject matter of the present invention rather unclear.

In addition, terms, such as first, second, A, B, (a), (b) or the like may be used herein when describing components of the present invention. Each of these terminologies is not used to define an essence, order or sequence of a corresponding component but used merely to distinguish the corresponding component from other component(s). In the case that it is described that a certain structural element “is connected to”, “is coupled to”, or “is in contact with” another structural element, it should be interpreted that another structural element may be connected to”, “be coupled to”, or “be in contact with” the structural elements as well as that the certain structural element is directly connected to or is in direct contact with another structural element.

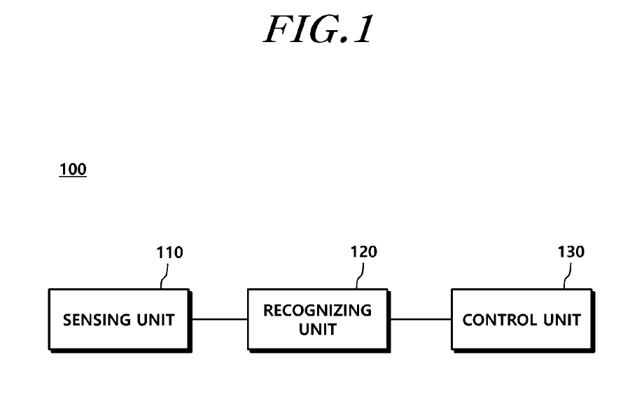

FIG. 1 is a view illustrating a configuration of a driving assistance apparatus according to one embodiment.

Referring to FIG. 1, a driving assistance apparatus 100 may include: a sensor 100 configured to sense information received from at least one of a camera configured to speed limit sign information, a navigation system configured to receive GPS information so as to sense road information for a road on which a vehicle is traveling, a vehicle speed sensor configured to sense vehicle speed information, and an input sensor configured to sense whether an input exists or not; a recognizing unit 120 configured to recognize a speed limit based a least one of the limit speed sign information and the road information; and a control unit 130 configured to control in such a manner that the traveling speed of the vehicle according to the vehicle speed information does not exceed the speed limit. When it is sensed that an input exists, the control is not performed.

The camera may include a light collecting unit configured to receive light, an imaging device configured to form an image using the received light, and an adjusting device configured to adjust a state. The light collecting unit is a component that receives light so as to cause an image to be captured on an imaging unit, and includes various types from a simple minute hole, like a pinhole camera, to a complicated one that uses multiple lenses. The light collecting unit of an ordinary camera includes a lens, an iris, and a device for adjusting a lens distance. The light collecting unit is generally referred to as a photographic lens. The imaging unit is a component on which an image produced by the light entering from the light collecting unit falls, and a film camera is configured to position a photosensitive film on the imaging unit so as to capture an image, so that the film is developed and printed to make a photograph. On the contrary, a digital camera includes a device that is configured to convert a light signal into an electric signal (e.g., a CMOS or a CCD) and positioned in the imaging unit so as to store digital images converted into electric signals in a storage medium as various forms of image files. The adjusting device is a component configured to operate so as to obtain a desired image. Typically, the adjusting device may include an iris configured to adjust a hole size of the light collecting unit and a shutter configured to receive or block light. For example, in a bright place, proper imaging may be performed by narrowing the iris in order to reduce the quantity of the light, and in a dark place, proper imaging may be performed by opening the iris in order to increase the quantity of the light. In addition, by increasing the operating speed of the shutter, a still image may be captured for a rapid motion of an athlete. In addition, devices, such as a flash for imaging in a dark place and a viewfinder for checking in advance an object to be imaged, may be included in the adjusting devices.

The navigation system is a global navigation satellite system designed to be used for a vehicle, which receives an electromagnetic wave sent from a satellite so as to calculate a distance from the satellite, and determines the position of the navigation system (latitude and longitude) based on the calculated distance. In addition, the navigation system provides a route to a destination based on peripheral information received from the satellite.

The vehicle speed sensor may be classified, for example, into: a reed switch type that is mounted in the vicinity of a rotary magnet within a speedometer or makes ON and OFF signals by the number of times, which is proportional to the vehicle speed, by the reed switch, thereby detecting the vehicle speed; a photoelectric type that detects a vehicle speed by a photo coupler that combines a light emitting diode and a phototransistor within the speedometer to face each other and an impeller driven by a speedometer cable; or an electromagnetic type that senses a change in the magnetic field according to the rotation of a magnet that is caused by the rotation of a speedometer or a meter doubling gear through a rotary shaft of a transmission.

The input sensor may sense that an input exists when: a certain input device including a button type input device, a rotary type input device, a touch type input device, or a pedal type input device operates; a pressed amount of an acceleration pedal of a vehicle exceeds a preset value; or the pressed state of the acceleration pedal of the vehicle is continued for a preset time.

That is, the sensing unit 110 may receive and sense the speed limit sign information, the road information on which the vehicle is traveling, vehicle speed information, and information as to whether an input exist or not from at least one of the camera, the navigation system, the vehicle speed sensor, and the input sensor which may operate as described above.

The recognizing unit 120 may recognize a speed limit based on at least one of the speed limit sign information and the road information.

The road information may include regional information including a downtown, a school zone, and a residential area, and may also include overspeed regulation information.

In general, the speed limit in the downtown may be 40 to 60 km per hour, the speed limit in the school zone designated to main school walkways of an elementary school and a kindergarten in order to protect children from a traffic accident may be 30 km per hour, and the speed limit in the residential area may be 30 to 40 km per hour.

The overspeed regulation information may include a section in which a speed camera or a movable speed camera is installed.

That is, the recognizing unit 120 may recognize a speed limit by a sensed speed limit sign information, or a speed limit according to a road on which the vehicle is traveling, based on received GPS information.

The control unit 130 may control a vehicle in such a manner that the traveling speed of the vehicle according to the vehicle speed information does not exceed the recognized speed limit, and when it is sensed that an input exists, the control unit 130 may not perform the control.

The driving assistance apparatus described above may conduct a control of preventing the overspeed of the vehicle by recognizing the speed limit of a road on which the vehicle is traveling, and may release the control according to the driver's input.

As described above, the driving assistance apparatus 100 according to an embodiment may further include a selection unit that generates selected information when regional information or overspeed regulation information is selected, and thus, the control unit 130 may control the vehicle in such a manner that the traveling speed of the vehicle does not exceed only the speed limit based on the selected information. The selection unit may allow the driver to select regional information or overspeed regulation information, and may further allow the driver to select detailed regional information (a downtown, a school zone, or a residential area).

In addition, the driving assistance apparatus 100 according to one embodiment may further include a notification providing unit that provides a notification to the driver. Then, the notification providing unit may provide at least one of a notification for vehicle speed information sensed by the sensing unit 110, a notification for a speed limit recognized by the recognizing unit 120, and a notification for notifying that the control unit 130 limits the traveling speed of the vehicle.

In addition, when the traveling speed of the vehicle exceeds the speed limit, a generating unit configured to request an order to limit the traveling speed of the vehicle to the driver, and thus to generate requested order information may be further included in the driving assistance apparatus 100 according to one embodiment. Thus, when the order information to limit the traveling speed of the vehicle is generated, the control unit may control the vehicle such that the traveling speed of the vehicle does not exceed the speed limit. The generating unit may operate using a device that may perform a Human Machine Interface (HMI).

Furthermore, the generating unit may request the order from the driver only when the traveling speed of the vehicle exceeds the sum of a speed limit and a preset critical speed. The critical speed may be easily set by the driver. Thereby, the number of order times requested from the driver may be adjusted.

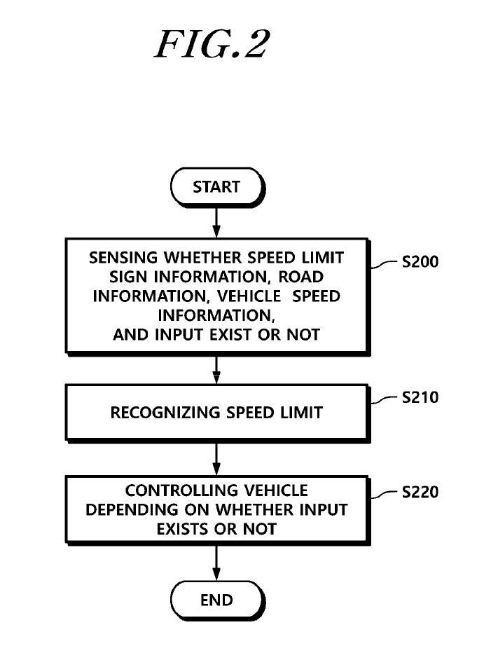

FIG. 2 is a view illustrating an example for describing a driving assistance apparatus according to one embodiment.

Referring to FIG. 2, the sensing unit of the driving assistance apparatus according to various embodiment senses speed limit sign information using a camera installed to monitor a speed limit sign at the front side, senses road information for a road on which the vehicle is traveling by using a navigation system configured to receive GPS information, and senses whether vehicle speed information of the vehicle and an input exist or not by using the vehicle speed sensor and the input sensor included in the vehicle (S200).

For example, for an image captured by the camera, the sensing unit may discriminate and sense the speed limit sign information based on a characteristic of the speed limit sign. That is, the sensing unit may discriminate the speed limit sign with reference to a red circle and a black figure of a predetermined size, which are characteristics of speed limit signs and may sense the information.

As another example, the sensing unit may sense the road information for a road on which the vehicle is traveling with reference to road information data according to a previously stored position using the position provided by the navigation system that receives GPS information.

As still another example, the sensing unit may sense vehicle speed information using the information provided by the vehicle speed sensor configured to sense the vehicle speed and included in the vehicle, and may sense whether an input exists or not based on a signal provided by the input sensor which senses an external input.

The input sensor may senses that an input exists when the driver manipulates an input device so that the input device operates, when the driver strongly steps on an acceleration pedal such that the pressed amount of the acceleration pedal is equal to or larger than a preset value, or when the user continuously steps on the acceleration pedal such that the acceleration pedal is continuously pressed for a preset critical time.

Thereafter, the recognizing unit recognizes a speed limit set for the road on which the vehicle is traveling based on at least one of the speed limit sign information and the road information sensed in step S200 (S210).

As an example, when only the speed limit sign information is sensed in step S200, the recognizing unit may recognize the speed limit set for the road on which the vehicle is traveling, based on the speed limit sign information.

As an example, when only the road information is sensed in step S200, the recognizing unit may recognize the speed limit set for the road on which the vehicle is traveling, based on the road information. In a detailed first example, when the vehicle travels on a road of a downtown, it is sensed as a downtown in step S200, and the recognizing unit may recognize 40 to 60 km per hour, which is the speed limit set to the downtown. In a detailed second example, when the vehicle travels on a road designated as a school zone, it is sensed as a school zone in step S200, and the recognizing unit may recognize 30 km per hour, which is the speed limit set to the school zone. In a detailed third example, when the vehicle travels on a road of a residential area, it is sensed as a residential area in step S200, and the recognizing unit may recognize 30 to 40 km per hour which is the speed limit set to the residential area.

As still another example, when the speed limit sign information and the road information are sensed in step S200, the recognizing unit may recognize, as a speed limit, a small speed value between the speed limit recognized based on the speed limit sign information and the speed limit recognized based on the road information. Although it is general that the speed limit recognized based on the speed limit sign information and the speed limit recognized based on the road information should be equal to each other, this may be caused due to the fact that the speed limits may be different from each other due to the non-replacement of the speed limit sign or non-replacement of road information according to a previously set position. Due to this reason, the navigation system may update the road information using a portable phone.

Thereafter, the control unit controls the vehicle depending on whether an input sensed in step S200 exists or not (S220).

As an example, when it is sensed that no input exists in step S200, the control unit may control the vehicle in such a manner that the traveling speed of the vehicle does not exceed the speed limit recognized in step S210. Unlike this, when it is sensed that an input exists in step S200, the control unit may not conduct the traveling speed control of the vehicle.

In a detailed example, the traveling speed of the vehicle may not exceed the recognized speed limit by limiting the pressed amount of the acceleration pedal.

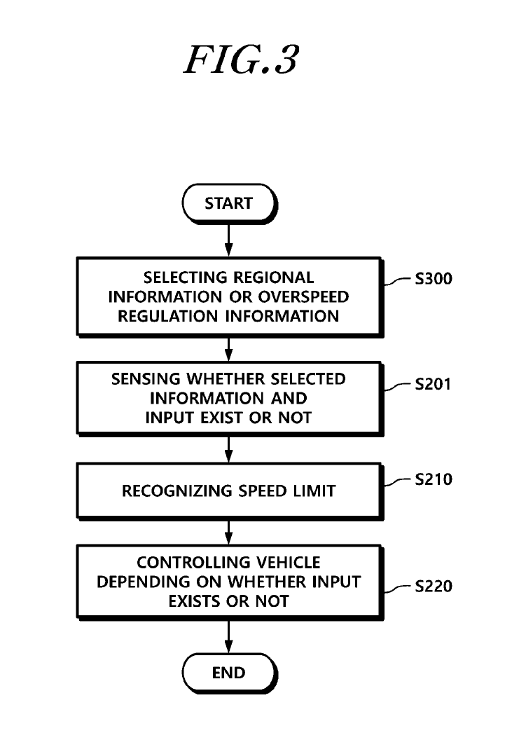

FIG. 3 is a view illustrating an example for describing a driving assistance apparatus according to another embodiment.

A driving assistance apparatus according to another embodiment may further include a selection unit configured to generate selected information when regional information or overspeed regulation information is selected, in addition to the driving assistance apparatus according to one embodiment described above with reference to FIG. 2, and thus, the control unit may control the vehicle in such a manner that the traveling speed of the vehicle does not exceed the speed limit based on the selected information.

Referring to FIG. 3, the selection unit of the driving assistance apparatus according to another embodiment may select whether to follow the speed limit based on the regional information from the driver or the speed limit based on the overspeed regulation information (S300). The regional information may be information as to whether a road is adjacent to a downtown, a school zone, or a residential area, or information as to whether the overspeed regulation information relates to an overspeed regulation section.

Thereafter, the sensing unit senses information selected using a device capable of sensing the information selected step S300, and senses whether an input exists or not using the input sensor (S201).

For example, when it is selected to follow the speed limit based on the regional information from the user in step S300, the sensing unit may only sense the regional information using the navigation system, and may sense whether an input exists or not using the input sensor.

Thereafter, the recognizing unit recognizes the speed limit based on the selected information sensed in step S201 (step S210), and depending on whether the input sensed in step S201 exists or not, the control unit controls the vehicle in such a manner that the traveling speed of the vehicle does not exceed the speed limit recognized in step S310 (S220).

According to a driving assistance apparatus according to another embodiment operating as illustrated in FIG. 3, the user may selectively follow the speed limit according to the regional information or the speed limit according to the overspeed regulation information as needed.

Meanwhile, in a case where when a vehicle travels in the school zone at a time point other than a time period of commuting to school, the driver may not feel it necessary to follow the speed limit of 30 km per hour according to the school zone. Thus, the driving assistance apparatus according to another embodiment may be selected to follow only the speed limit based on the overspeed regulation information from the driver so as to control the vehicle not to follow the speed limit of 30 km per hour according to the school zone.

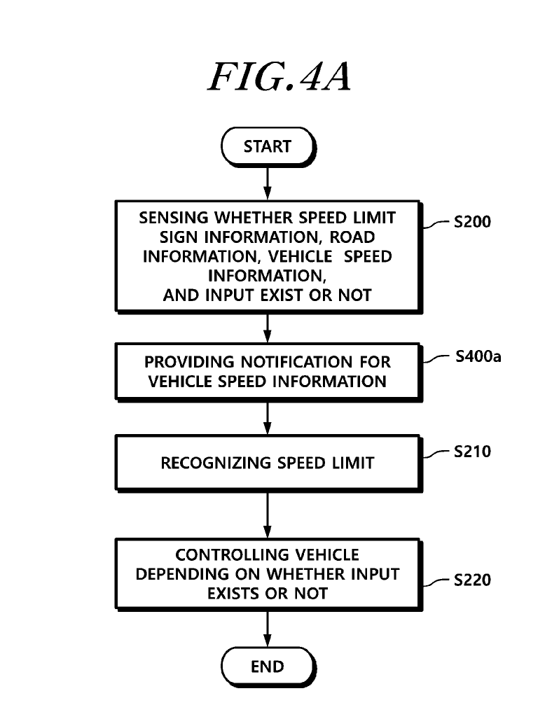

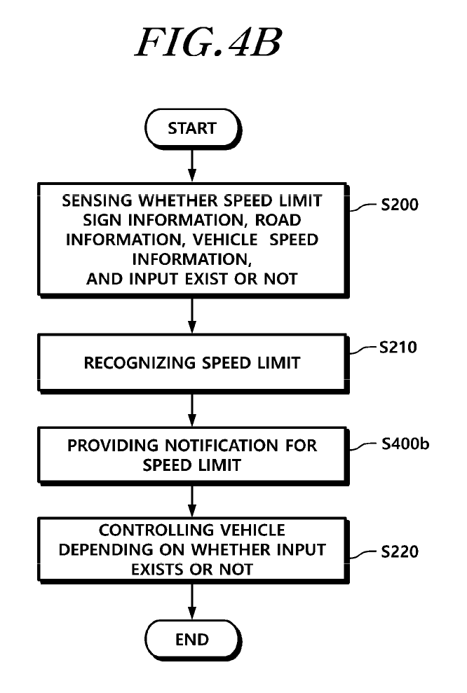

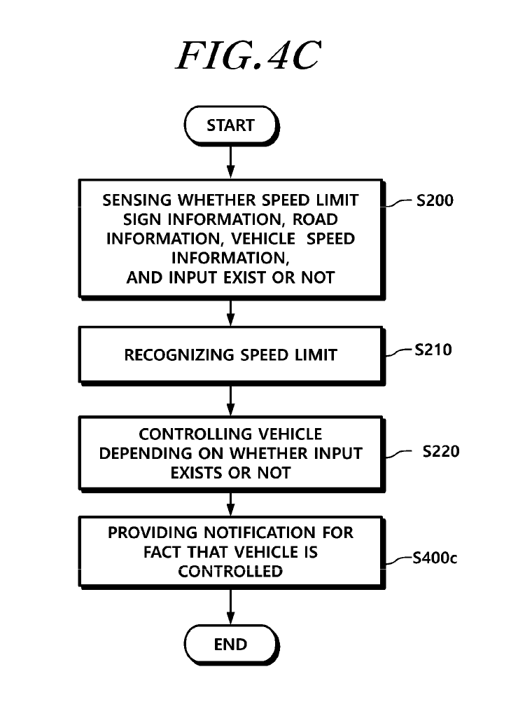

FIG. 4A is a view illustrating a first example for describing an operation of a driving assistance apparatus according to still another embodiment. FIG. 4B is a view illustrating a second example for describing an operation of a driving assistance apparatus according to still another embodiment. FIG. 4C is a view illustrating a third example for describing an operation of a driving assistance apparatus according to still another embodiment.

A driving assistance apparatus according to still another embodiment may further include a notification providing unit that provides a notification to the driver in the driving assistance apparatus according to one embodiment that operates as illustrated in FIG. 2. Thus, the driving assistance apparatus according to still another embodiment may provide at least one of a notification as to sensed vehicle speed information, a notification as to a recognized speed limit, and a notification as to the fact that the vehicle is controlled.

Referring to FIG. 4A, the sensing unit senses speed limit sign information using a camera installed to monitor a speed limit sign at the front side, senses road information for a road on which the vehicle is traveling by using a navigation system configured to receive GPS information, and senses whether vehicle speed information and an input exist or not by using the vehicle speed sensor and the input sensor included in the vehicle (S200).

Thereafter, the notification providing unit provides a notification for the vehicle speed information sensed in step S200 to the driver (S400a).

For example, the notification providing unit may provide sound, light, vibration, and so on, which vary depending on a range of vehicle speed, to the driver.

Thereafter, the recognizing unit recognizes a speed limit set to a road on which the vehicle is traveling, based on at least one of the speed limit sign information and road information sensed in step S200 (S210), and the control unit controls the vehicle depending on whether an input sensed in step S200 exists or not (S220).

As the driving assistance apparatus according to still another embodiment operates as illustrated in FIG. 4A, the driver may recognize the traveling speed of the vehicle.

In addition, referring to FIG. 4B, the sensing unit senses speed limit sign information using a camera installed to monitor a speed limit sign at the front side, senses road information for a road on which the vehicle is traveling by using a navigation system configured to receive GPS information, and senses whether vehicle speed information and an input exist or not by using the vehicle speed sensor and the input sensor included in the vehicle (S200), and the recognizing unit recognizes a speed limit set for the road on which the vehicle is traveling, based on at least one of the speed limit sign information and the road information sensed in step S200 (S210).

Thereafter, the notification providing unit provides a notification for the speed limit recognized in step S210 to the driver (S400b).

For example, the notification providing unit may provide sound, light, vibration, and so on, which vary depending on a range of recognized speed limit, to the driver. Different vibrations may mean that intensities or generating periods are different from each other.

Thereafter, the control unit controls the vehicle depending on whether an input sensed in step S200 exists or not (S220).

As the driving assistance apparatus according to still another embodiment operates as illustrated in FIG. 4B, the driver may recognize the speed limit of the road on which the vehicle is traveling.

Referring to FIG. 4C, the sensing unit senses speed limit sign information using a camera installed to monitor a speed limit sign at the front side, senses road information for a road on which the vehicle is traveling by using a navigation system configured to receive GPS information, and senses whether vehicle speed information and an input exist or not by using the vehicle speed sensor and the input sensor included in the vehicle (S200), the recognizing unit recognizes a speed limit set to a road on which the vehicle is traveling, based on at least one of the speed limit sign information and road information sensed in step S200 (S210), and the control unit controls the vehicle depending on whether an input sensed in step S200 exists or not (S220).

Thereafter, the notification providing unit provides a notification as to the fact that the vehicle is controlled in step S220 to the driver (S400c).

For example, the notification providing unit may provide sound, light, vibration, and so on, which vary depending on a range of recognized speed limit, to the driver.

As the driving assistance apparatus according to still another embodiment operates as illustrated in FIG. 4C, the driver may recognize that the vehicle is controlled and the speed of the vehicle is out of the ordinary.

Hereinafter, a driving assistance method will be briefly described, which is an operation performed by the driving assistance apparatuses, which have been described with reference to FIGS. 1 to 4C.

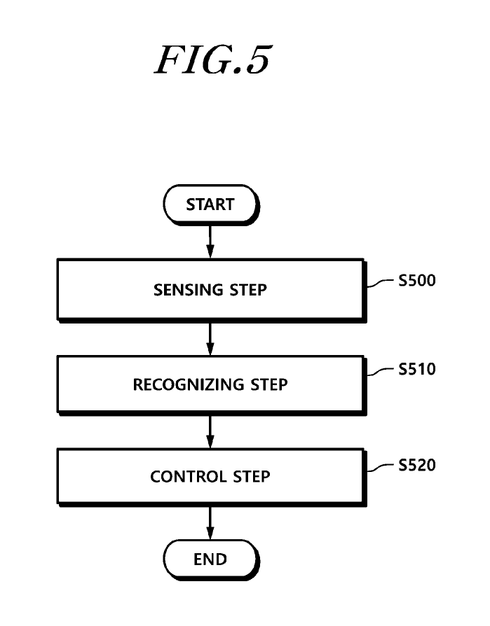

FIG. 5 is a view illustrating a flow chart of a driving assistance method according to one embodiment.

Referring to FIG. 5, a driving assistance method according to an embodiment may include: a sensing step of sensing at least one of speed limit sign information obtained using a camera, a road information obtained using a navigation system that receives GPS information, vehicle speed information obtained using a vehicle speed sensor, and input information obtained using an input sensor (S500); a recognizing step of recognizing a speed limit based on at least one of the speed limit sign information and the road information (S510); and a control step of controlling the vehicle in such a manner that the traveling speed of the vehicle does not exceed the speed limit, in which, when the input information is sensed, the control is not performed (S520).

The camera may include a light collecting unit configured to receive light, an imaging device configured to form an image using the received light, and an adjusting device configured to adjusting a state. The light collecting unit is a component that receives light so as to cause an image to fall on an imaging unit, and includes various types from a simple minute hole, like a pinhole camera, to a complicated one that uses multiple lenses. The light collecting unit of an ordinary camera includes a lens, an iris, and a device for adjusting a lens distance. The light collecting unit is generally referred to as a photographic lens. The imaging unit is a component on which an image produced by the light entering from the light collecting unit falls, and a film camera is configured to position a photosensitive film on the imaging unit so as to capture an image, so that the film is developed and printed to make a photograph. On the contrary, a digital camera includes a device that is configured to convert a light signal into an electric signal (e.g., a CMOS or a CCD) and positioned in the imaging unit so as to store digital images converted into electric signals in a storage medium as various forms of image files. The adjusting device is a component configured to operate so as to obtain a desired image. Typically, the adjusting device may include an iris configured to adjust a hole size of the light collecting unit and a shutter configured to receive or block light. For example, in a bright place, proper imaging may be performed by narrowing the iris in order to reduce the quantity of the light, and in a dark place, proper imaging may be performed by opening the iris in order to increase the quantity of the light. In addition, by increasing the operating speed of the shutter, a still image may be captured for a rapid motion of an athlete. In addition, devices, such as a flash for imaging in a dark place and a viewfinder for checking in advance an object to be imaged, may be included in the adjusting devices.

The navigation system is a global navigation satellite system designed to be used for a vehicle, which receives an electromagnetic wave sent from a satellite so as to calculate a distance from the satellite, and determines the position of the navigation system (latitude and longitude) based on the calculated distance. In addition, the navigation system provides a route to a destination based on peripheral information received from the satellite.

The vehicle speed sensor may be classified, for example, into: a reed switch type that is mounted in a vicinity of a rotary magnet within a speedometer or makes ON and OFF signals by the number of times, which is proportional to the vehicle speed, by the reed switch, thereby detecting the vehicle speed; a photoelectric type that detects a vehicle speed by a photo coupler that combines a light emitting diode and a phototransistor within the speedometer to face each other and an impeller driven by a speedometer cable; or an electromagnetic type that senses a change in the magnetic field according to the rotation of a magnet that is caused by the rotation of a speedometer or a meter doubling gear through a rotary shaft of a transmission.

The input sensor may sense that an input exists when a certain input device including a button type input device, a rotary type input device, a touch type input device, or a pedal type input device operates, when the pressed amount of an acceleration pedal of a vehicle exceeds a preset value, or when the pressed state of the acceleration pedal of the vehicle is continued for a preset time.

That is, in the sensing step (S500) the speed limit sign information, the road information on which the vehicle is traveling, vehicle speed information, and information as to whether an input exist or not may be received and sensed from at least one of the camera, the navigation system, the vehicle speed sensor, and the input sensor which may operate as described above.

In the recognizing step (S510), a speed limit may be recognized based on at least one of the speed limit sign information and the road information.

The road information may include regional information including a downtown, a school zone, and a residential area and overspeed regulation information. In general, the speed limit in the downtown may be 40 to 60 km per hour, the speed limit in the school zone designated to main school walkways of an elementary school and a kindergarten in order to protect children from a traffic accident may be 30 km per hour, and the speed limit in the residential area may be 30 to 40 km per hour.

The overspeed regulation information may include a section in which a speed camera or a movable speed camera is installed.

That is, in the recognizing step (S510), a speed limit may be recognized by a sensed speed limit sign information, or a speed limit according to a road on which the vehicle is traveling may be recognized based on received GPS information.

In the control step (S520), a vehicle may be controlled in such a manner that the traveling speed of the vehicle according to the vehicle speed information does not exceed the recognized speed limit, and when it is sensed that an input exists, the control may not be performed.

The driving assistance apparatus described above may conduct a control of preventing the overspeed of the vehicle by recognizing the speed limit of a road on which the vehicle is traveling, and may release the control according to the driver's input.

The driving assistance method according to an embodiment as described above may further include a selection step of generating selected information when regional information or overspeed regulation information is selected, and thus, in the control step (S520), the vehicle may be controlled in such a manner that the traveling speed of the vehicle does not exceed only the speed limit based on the selected information. In the selection step, the driver may select regional information or overspeed regulation information, and may further select detailed regional information (a downtown, a school zone, or a residential area).

In addition, the driving assistance step according to one embodiment may further include a notification providing step of providing a notification to the driver. Then, the notification providing step may provide at least one of a notification for vehicle speed information sensed in the sensing step (S500), a notification for a speed limit recognized in the recognizing step (S510), and a notification for notifying that the traveling speed of the vehicle in the control step (S520).

In addition, when the traveling speed of the vehicle exceeds the speed limit, a generating step of requesting an order to limit the traveling speed of the vehicle to the driver, and thus generating requested order information may be further included in the driving assistance method according to one embodiment. Thus, when the order information to limit the traveling speed of the vehicle is generated, the control step may control the vehicle such that the traveling speed of the vehicle does not exceed the speed limit. The generating step may be performed using a device that may perform a Human Machine Interface (HMI).

Furthermore, the generating step may request the order from the driver only when the traveling speed of the vehicle exceeds the sum of a speed limit and a preset critical speed. The critical speed may be easily set by the driver. Thereby, the number of order times requested from the driver may be adjusted.

In addition, the driving assistance method may conduct all the operations that are conducted by the driving assistance apparatuses described above with reference to FIGS. 1 to 4C.

The above description and the accompanying drawings provide examples of the technical idea for illustrative purposes only, and those having ordinary knowledge in the technical field, to which the present embodiments pertains, will appreciate that various modifications and changes such as combinations, separations, substitutions, and changes of configurations are possible without departing from the essential features. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

What is claimed is:

1. A driving assistance apparatus comprising:
a sensing unit configured to receive and sense information from at least one of a camera configured to sense speed limit sign information, a navigation system configured to sense road information for a road on which a vehicle is traveling by receiving GPS information, a vehicle speed sensor configured to sense vehicle speed information, and an input sensor configured to sense whether an input exists or not;
a recognizing unit configured to recognize a speed limit based on at least one of the speed limit sign information and the road information; and
a control unit configured to control a vehicle in such a manner that the traveling speed of the vehicle according to the vehicle speed information does not exceed the recognized speed limit, wherein, when it is sensed that an input exists, the control unit does not perform the control.

2. The driving assistance apparatus of claim 1, wherein the input sensor senses that the input exists when the input device operates, when a pressed amount of an acceleration pedal of the vehicle is equal to or larger than a preset value, or when the acceleration pedal is continuously pressed for a preset critical time.

3. The driving assistance apparatus of claim 1, wherein the road information includes regional information including a downtown, a school zone, and a residential area, and also includes overspeed regulation information.

4. The driving assistance apparatus of claim 3, further comprising:
a selection unit configured to generate selected information when the regional information or the overspeed regulation information is selected,
wherein the control unit controls the vehicle in such a manner that the traveling speed of the vehicle does not exceed only the speed limit based on the selected information.

5. The driving assistance apparatus of claim 1, wherein the control unit limits an output signal obtained when an acceleration pedal of the vehicle is pressed to a predetermined amount such that the traveling speed of the vehicle does not exceed the speed limit.

6. The driving assistance apparatus of claim 1, wherein the control unit limits an output signal obtained when an acceleration pedal of the vehicle is pressed such that the traveling speed of the vehicle does not exceed the speed limit.

7. The driving assistance apparatus of claim 1, wherein the navigation system updates the road information using a portable phone.

8. The driving assistance apparatus of claim 1, further comprising:
a notification providing unit configured to provide a notification to a driver,
wherein the notification providing unit provides at least one of a notification as to the vehicle speed information, a notification as to the speed limit, and a notification as to a fact that the vehicle is controlled.

9. The driving assistance apparatus of claim 1, further comprising:
a generating unit configured to request an order to limit the traveling speed of the vehicle from a driver when the traveling speed of the vehicle exceeds the speed limit, and to generate order information requested thereby,
wherein, when the order information to limit the traveling speed of the vehicle is generated, the control unit controls the vehicle in such a manner that the traveling speed of the vehicle does not exceed the speed limit.

10. The driving assistance apparatus of claim 9, wherein, when the traveling speed of the vehicle exceeds a sum of the speed limit and a preset critical speed, the generating unit requests the order from the driver.

11. A driving assistance method comprising:
a sensing step of sensing at least one of speed limit sign information obtained using a camera, a road information obtained using a navigation system that receives GPS information, vehicle speed information obtained using a vehicle speed sensor, and input information obtained using an input sensor;
a recognizing step of recognizing a speed limit based on at least one of the speed limit sign information and the road information; and
a control step of controlling the vehicle in such a manner that the traveling speed of the vehicle does not exceed the recognized speed limit, wherein, when input information is sensed, the control is not performed.
